(19) United States
(12) Patent Application Publication
(10) Pub. No.: US 2006/0206902 A1
(43) Pub. Date: Sep. 14, 2006

(54) Variable interleaved multithreaded processor method and system

(76) Inventors: Sujat Jamil, Austin, TX (US); Erich Plondke, Austin, TX (US); Lucian Codrescu, Austin, TX (US); Muhammad Ahmed, Austin, TX (US); William C. Anderson, Austin, TX (US)

Correspondence Address: QUALCOMM INCORPORATED, 5775 MOREHOUSE DR., SAN DIEGO, CA, 92121, US

(21) Appl. No.: 11/080,239

(22) Filed: Mar. 14, 2005

(51) Int. Cl. G06F 9/46

(52) U.S. Cl. 718/108

(57) ABSTRACT

Techniques for processing transmissions in a communications (e.g., CDMA) system. A multithreaded processor processes a plurality of threads operating via a plurality of processor pipelines associated with the multithreaded processor and predetermines a triggering event for the multithreaded processor to switch from a first thread to a second thread. The triggering event is variably and dynamically determined to optimize multithreaded processor performance. The triggering event may be a dynamically determined number of processor cycles, the number being determined to optimize the performance of the multithreaded processor, or a variably and dynamically determined event, such as a cache or instruction miss.

### FIELD

The disclosed subject matter relates to data communication. More particularly, this disclosure relates to a novel and improved method and apparatus for variable interleaved processing in a multithreaded processor system.

### DESCRIPTION OF THE RELATED ART

A modern day communications system must support a variety of applications. One such communications system is a code division multiple access (CDMA) system that supports voice and data communication between users over a terrestrial link. The use of CDMA techniques in a multiple access communication system is disclosed in U.S. Pat. No. 4,901,307, entitled “SPREAD SPECTRUM MULTIPLE ACCESS COMMUNICATION SYSTEM USING SATELLITE OR TERRESTRIAL REPEATERS,” and U.S. Pat. No. 5,103,459, entitled “SYSTEM AND METHOD FOR GENERATING WAVEFORMS IN A CDMA CELLULAR TELEHANDSET SYSTEM,” both assigned to the assignee of the claimed subject matter.

A CDMA system is typically designed to conform to one or more standards. One such first generation standard is the “TIA/EIA/IS-95 Terminal-Base Station Compatibility Standard for Dual-Mode Wideband Spread Spectrum Cellular System,” hereinafter referred to as the IS-95 standard. The IS-95 CDMA systems are able to transmit voice data and packet data. A newer generation standard that can more efficiently transmit packet data is offered by a consortium named “3^{rd} Generation Partnership Project” (3GPP) and embodied in a set of documents including Document Nos. 3G TS 25.211, 3G TS 25.212, 3G TS 25.213, and 3G TS 25.214, which are readily available to the public. The 3GPP standard is hereinafter referred to as the W-CDMA standard.

Digital signal processors (DSPs) are frequently being used in wireless handsets complying with the above standards. Hardware multithreading is becoming a potentially useful technique in such DSPs. Several multithreaded DSPs have been announced by industry or are already into production in the areas of high-performance microprocessors, media processors, and network processors.

The manifestation of multithreading in a DSP may occur at different levels or at differing degrees of process granularity. For example, a fine-grained form of multithreading that a DSP may perform uses two or more threads of control in parallel within the processor pipeline. The contexts of two or more threads of control are often stored in separate on-chip register sets. Unused instruction slots, which arise from latencies during the pipelined execution of single-threaded programs by a contemporary microprocessor, are filled by instructions of other threads within a multithreaded processor. The execution units are multiplexed between the thread contexts that are loaded in the register sets.

With wireless handset using multithreaded DSPs, there is the need to conserve the power or, more specifically, energy (i.e., power over time). This is because multimedia wireless handsets are and will be consuming increasing amounts of battery or power source energy. For example, a wireless handset providing live television broadcast reception requires the wireless handset to consume battery energy continuously, as opposed to intermittently such as occurs with normal two-way call traffic. The multithreaded DSP for wireless handset operations addresses this concern of efficiently using power sources by processing instructions for as many processor cycles as possible using the present processing architecture. However, problems with existing approaches yet exist.

An important problem to solve in multithreaded DSPs relates to the thread scheduling, i.e., the way in which a DSP determines how to switch processing between threads. Unfortunately, it often occurs that different application mixes may be optimal at different switching intervals. For example, for a DSP with N threads, it may be optimal to switch every cycle. For another DSP with N/2 threads, switching every two cycles may be optimal. In some situations, the same application may be optimal with one switch interval during one part of the application, and a different one during another part. There is a need, therefore, for a method and system that solves a variety of resource use problems associated thread switching of multithreaded digital signal processing.

Attempts to solve these problems have been unsuccessful, due to traditional DSP architectures being set or established for a specific or inflexible application. For example, a user orientation application problem usually tends to benefit more from certain types of multithreaded operations, whereas scientific applications tend to benefit more from other types of multithreaded operations. As a result, different processors can and have been designed for different applications, but the same processors are not optimal for both applications. Unfortunately, wireless handsets are requiring and increasingly will require that their DSP process user orientation, scientific, and multimedia applications, as well as many other types of applications for which a single approach to multithreaded operations provides a workable solution. Accordingly, a need exists for a wireless handset multithreaded DSP capable of optimal operations with a wide variety of applications.

### SUMMARY

Techniques for variable interleaved processing with a multithreaded processor system are disclosed for improving both the operation of the processor and the efficient use of wireless handset energy resources by assuring that a multithreaded processor processes instructions for a maximal portion of its operational time.

An embodiment of the disclosure provides a method for processing instructions on a multithreaded processor. The multithreaded processor processes a plurality of threads operating via a plurality of processor pipelines associated with the multithreaded processor. The method includes the steps of predetermining at least one triggering event for the multithreaded processor to switch from a first thread to a second thread. The triggering event is variably and dynamically determined to optimize multithreaded processor performance. The method and system process a first set of instructions from a first thread until the occurrence of the triggering event. Switching the multithreaded processor from processing the first thread to processing a second thread occurs upon the triggering event. Processing a second set of instructions from the second thread continues until the next occurrence of the triggering event. The method and system continue the processing and switching steps until the multithreaded processor processes all sets of instructions requiring processing are processed from the plurality of threads.

The triggering event may be a dynamically determined number of processor cycles, the number of which may be predetermined to optimize the performance of the multithreaded processor. In such case, the embodiment counts the number of processor cycles to determine whether the counted number of processor cycles equals the predetermined number of processor cycles, thereby establishing the presence of the triggering event. Alternatively, an embodiment may establish the triggering event as a variably and dynamically determined event, such as may occur in a blocked multithreaded processor. As such, the triggering event may be a cache or instruction miss. Moreover, the disclosed embodiment may combine a first triggering event of a predetermined number of processor cycles with a second triggering event of a blocking event, both triggering events being variably and dynamically predetermined.

These and other advantages of the disclosed subject matter, as well as additional inventive features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages be included within this description, be within the scope of the accompanying claims.

### BRIEF DESCRIPTIONS OF THE DRAWINGS

The features, nature, and advantages of the disclosed subject matter will become more apparent from the detailed description set forth below when taken in conjunction with the drawings in which like reference characters identify correspondingly throughout and wherein:

FIG. 1 is a simplified block diagram of a communications system that can implement the present embodiment;

FIG. 2 illustrates a DSP architecture for carrying forth the teachings of the present embodiment;

FIGS. 3 through 6 show instruction issue vs. processor cycle diagrams for displaying certain aspects of various embodiments of the claimed subject matter; and

FIGS. 7 through 9 are flow diagrams depicting various processing flows that may effect the different embodiments of a variable multithreaded processor method and system.

### DETAILED DESCRIPTION OF THE SPECIFIC EMBODIMENTS

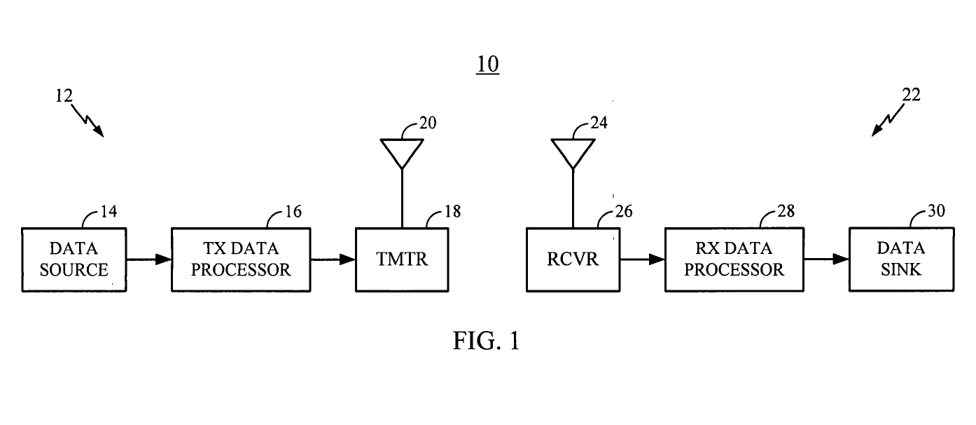

FIG. 1 is a simplified block diagram of a communications system 10 that can implement the presented embodiments. At a transmitter unit 12, data is sent, typically in blocks, from a data source 14 to a transmit (TX) data processor 16 that formats, codes, and processes the data to generate one or more analog signals. The analog signals are then provided to a transmitter (TMTR) 18 that modulates, filters, amplifies, and up converts the baseband signals to generate a modulated signal. The modulated signal is then transmitted via an antenna 20 to one or more receiver units.

At a receiver unit 22, the transmitted signal is received by an antenna 24 and provided to a receiver (RCVR) 26. Within receiver 26, the received signal is amplified, filtered, down converted, demodulated, and digitized to generate in phase (I) and (Q) samples. The samples are then decoded and processed by a receive (RX) data processor 28 to recover the transmitted data. The decoding and processing at receiver unit 22 are performed in a manner complementary to the coding and processing performed at transmitter unit 12. The recovered data is then provided to a data sink 30.

The signal processing described above supports transmissions of voice, video, packet data, messaging, and other types of communication in one direction. A bi-directional communications system supports two-way data transmission. However, the signal processing for the other direction is not shown in FIG. 1 for simplicity.

Communications system 10 can be a code division multiple access (CDMA) system, a time division multiple access (TDMA) communications system (e.g., a GSM system), a frequency division multiple access (FDMA) communications system, or other multiple access communications system that supports voice and data communication between users over a terrestrial link. In a specific embodiment, communications system 10 is a CDMA system that conforms to the W-CDMA standard.

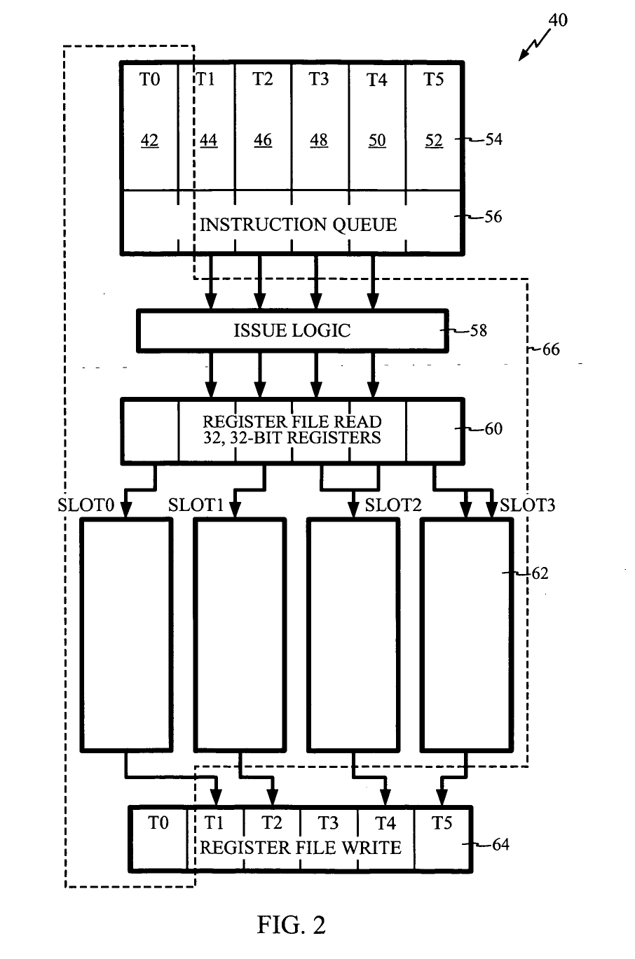

FIG. 2 illustrates DSP 40 architecture that may serve as the transmit data processor 16 and receive data processor 28 of FIG. 1. Recognize that DSP 40 only represents one embodiment among a great many of possible digital signal processor embodiments that may effectively use the teachings and concepts here presented. In DSP 40, therefore, threads T0 through T5 (reference numerals 42 through 52), contain sets of instructions from different threads. Circuit 54 represents the instruction access mechanism and is used for fetching instructions for threads T0 through T5. Instructions for circuit 54 are queued into instruction queue 56. Instructions in instruction queue 56 are ready to be issued into processor pipeline 66 (see below). From instruction queue 56, a single thread, e.g., thread T0, may be selected by issue logic circuit 58. Register file 60 of selected thread is read and read data is sent to execution data paths 62. for slot0 through slot3. Slot0 through slot3, in this example, provide for the packet grouping combination employed in the present embodiment.

Output from execution data paths 62 goes to register file write circuit 64, also configured to accommodate individual threads T0 through T5, for returning the results from the operations of DSP 40. Thus, the data path from circuit 54 and before to register file write circuit 64 being portioned according to the various threads forms a processing pipeline 66.

The present embodiment may employ a hybrid of a heterogeneous element processor (HEP) system using a single microprocessor with up to six threads, T0 through T5. Processor pipeline 66 has six stages, matching the minimum number of processor cycles necessary to fetch a data item from circuit 54 to registers 60 and 64. DSP 40 concurrently executes instructions of different threads T0 through T5 within a processor pipeline 66. That is, DSP 40 provides six independent program counters, an internal tagging mechanism to distinguish instructions of threads T0 through T5 within processor pipeline 66, and a mechanism that triggers a thread switch. Thread-switch overhead varies from zero to only a few cycles.

The present embodiment allows thread switching not only upon the occurrence of predetermined number of clock cycles, but also with the occurrence of a particular event, such as an external event. Such an external event may be, for example, a data cache miss or instruction cache miss. In fact, the system may issue an interrupt, which interrupt may be used or treated as an external event to initiate thread switching. Therefore, for example, with a process requiring significant processor resources, the present embodiment may provide, for example, access to processor resources for one million clock cycles. After one million clock cycles, the processor may switch the control thread to the next control thread. If the next control thread requires only ten thousand clock cycles, then the present embodiment causes the processor to allocate only the required ten thousand clock cycles to the thread.

FIGS. 3 through 6 show instruction issue vs. processor cycle diagrams for displaying certain aspects of the various embodiments of the present subject matter. In particular, FIG. 3 presents an instruction issue vs. processor cycle diagram 70 for IMT operation of DSP 40.

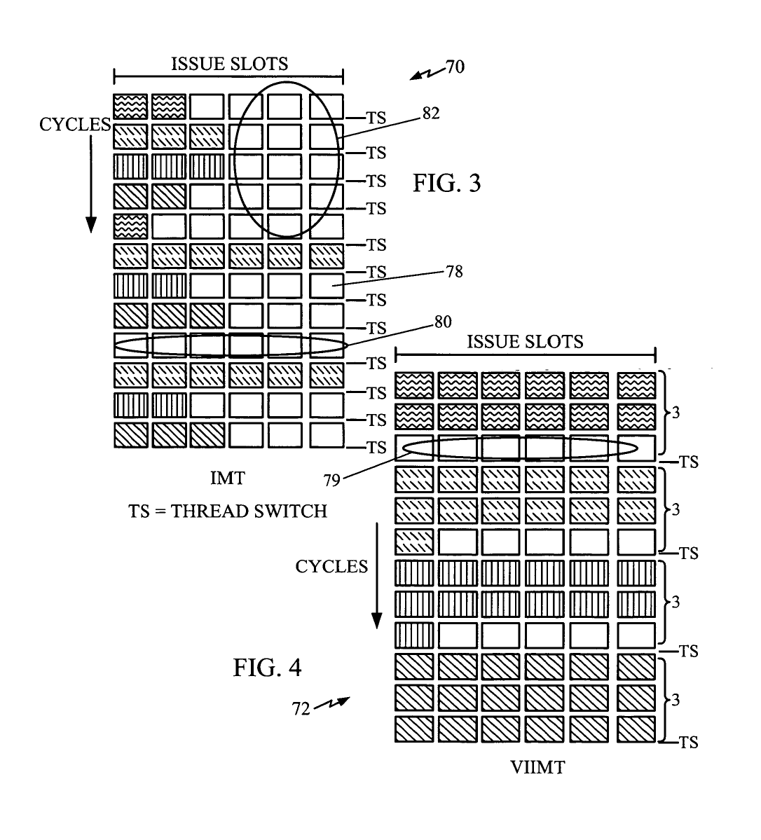

FIG. 4 shows diagram 72 relating to VIIMT operation of the present embodiment.

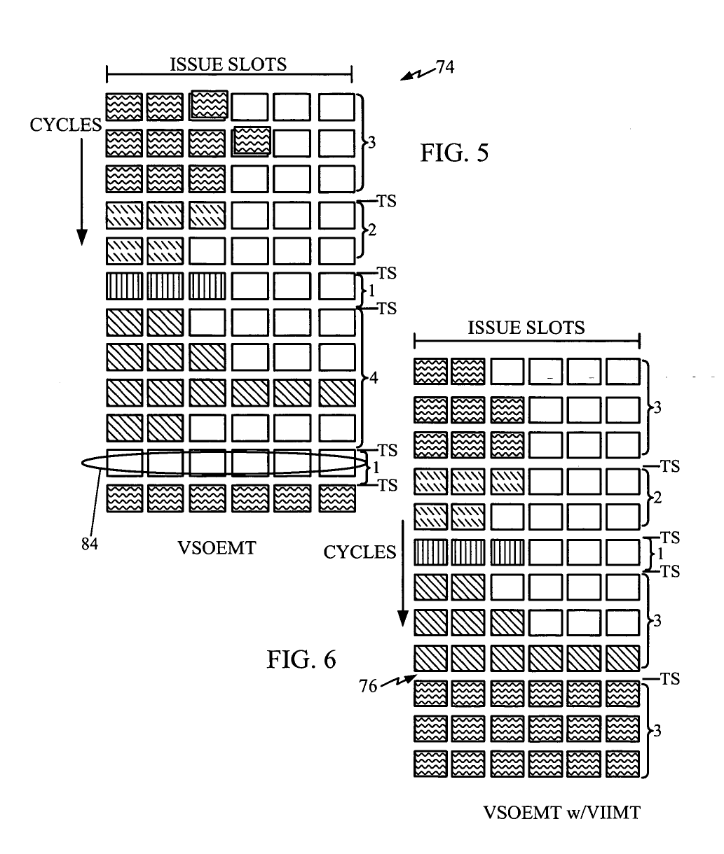

FIG. 5 shows diagram 74 for one embodiment of VSOEMT operation with DSP 40.

FIG. 6 further presents diagram 76 to show the benefits of combining the VSOEMT processing with VIIMT processing.

In all of FIGS. 3 through 5, empty issue slots, such as empty slot 78 (FIG. 3) can be defined as either vertical or horizontal waste. Vertical waste 80 occurs when DSP 40 issues no instructions in a cycle, i.e., there is instruction issue stalling. Horizontal waste 82 occurs when DSP 40 fills only a non-empty subset of the slots available at a given cycle.

As FIG. 3 shows, IMT performs a thread switch TS by switching the processed thread at every cycle, regardless of whether a long-latency event occurs. As such, DSP 40 resources are interleaved among a pool of ready threads, T0 through T5, at a single-cycle granularity.

In FIG. 4, the VIIMT operation varies from the IMT switching by switching at a dynamically determined interval; here three (3) processor cycles. Note that the variable processor cycles being set at three may yet result in some vertical waste 79. FIG. 5 depicts the processor cycles vs. instruction issue occurring wherein the triggering event is dynamically determined, such as a cache miss or instruction miss. As can be seen, the processing cycles between thread switches vary from four (4) cycles t6 only one (1) cycle, such as in the event of vertical waste. That is, although the diagram may be similar to the conventional SOEMT processor cycle vs. instruction issue diagram, the event is dynamically determined with the present embodiment. Still, though, in some instances vertical waste 84 may occur. As can be seen, in FIG. 6, the combination of VSOEMT and VIIMT substantially reduces both vertical waste and horizontal waste. The effect is that DSP 40 executes instructions for a measurably greater portion of its operational cycles.

The VSOEMT process of the present embodiment dynamically selects the type of event that may result in a thread switch. Usually such a situation arises when the instruction execution reaches a long-latency operation or a situation where a latency may arise. Such events are described below to illustrate the flexibility of the present embodiment.

For example, the VSOEMT process may execute a switch-on-cache-miss process that switches the thread if a load or store misses in the cache. In such a process, only those loads that miss in the cache and those stores that cannot be buffered have long latencies and cause thread switches. The switch-on-signal process switches thread on the occurrence of a specific signal, for example, signaling an interrupt, trap, or message arrival. The switch-on-use process switches when an instruction tries to use the still missing value from a load (which, for example, missed in the cache).

Another event that may be dynamically determined for which switching may occur is a conditional-switch, which couples an explicit switch instruction with a condition. In such a process, a thread is switched only when the condition is fulfilled; otherwise the thread switch is ignored. A conditional switch instruction may be used, for example, after a group of load/store instructions. In such an instance, the thread switch is ignored if all load instructions (in the preceding group) hit the cache. Otherwise, the thread switch is performed. Moreover, a conditional switch instruction could also be added between a group of loads and their subsequent use to realize a lazy thread switch, instead of implementing the switch-on-use model.

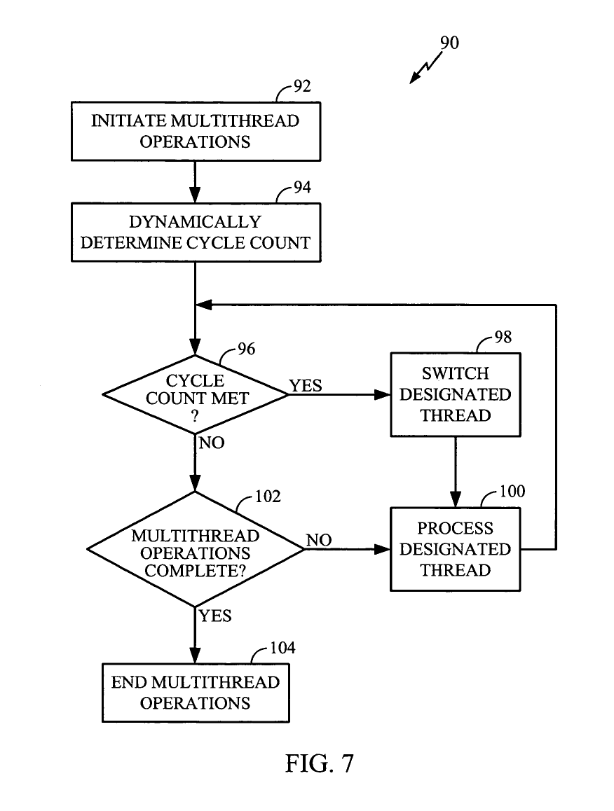

FIGS. 7 through 9 present flow diagrams depicting various examples of the variable multithreaded processor method and system of the present embodiment. Referring to FIG. 7, VIIMT process 90 may be thought of as beginning at step 92 at which point DSP 40 multithreaded operations initiate. At step 94, VIIMT process 90 dynamically predetermines the number of cycles at which DSP 40 switches from a first thread to a second thread. The number of cycles determined at step 94 may be considered as a triggering event that is variably and dynamically determined to optimize multithreaded processor performance. Such considerations may be the amount of DSP 40 resources needed to execute the set of instructions that a thread contains. While multithread operations occur, VIIMT process tests, at query 96, whether the predetermined number of cycles has been reached. If so, then process flow goes to step 98, at which point DSP 40 switches from processing the first thread to processing a second thread. Thereupon, process flow goes to step 100 for DSP 40 to process the new thread. In VIIMT process 90, flow continues back to query 96, always verifying the number of processor cycles. Now, if the number of processor cycles has not yet been met, then VIIMT process 90 continues to query 102 for testing whether multithread operations are complete. If so, process flow goes to step 104 for terminating multithread operations. Otherwise, process flow continues to step 100 for continuing to process the current thread.

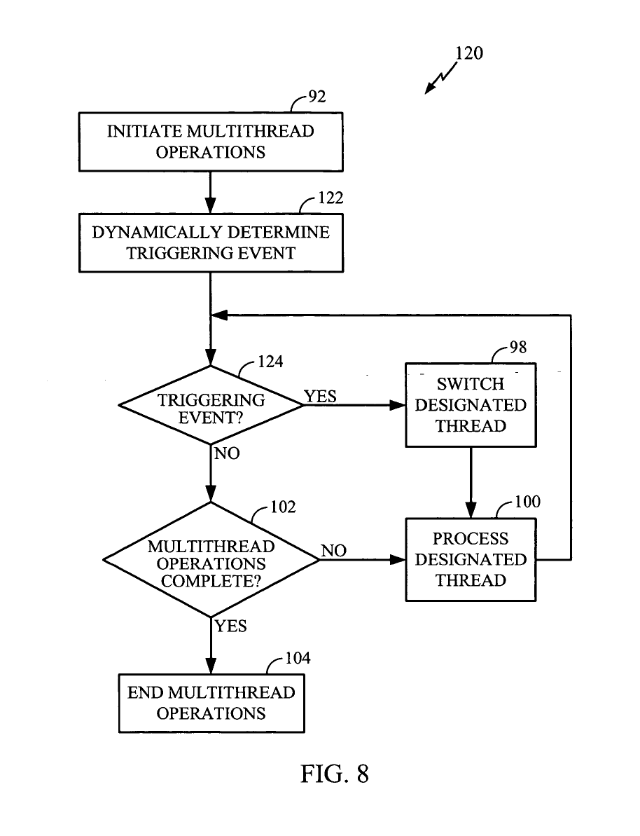

FIG. 8 shows VSOEMT process flow 120, which begins, as did VIIMT process flow 90, with step 92 at which DSP 40 may be considered as initiating multithread operations. Process flow then proceeds to step 122 whereupon VSOEMT process flow 120 dynamically determines a triggering event. Once the triggering event has been determined, process flow continues to query 124 for testing whether the triggering event has occurred. If the triggering event has occurred, then process flow continues to steps 98 and 100 for, respectively, switching the thread and continuing with DSP 40 thread processing. Otherwise, process flow continues to query 102 and otherwise operates in a manner similar to VIIMT process flow 90 of FIG. 7.

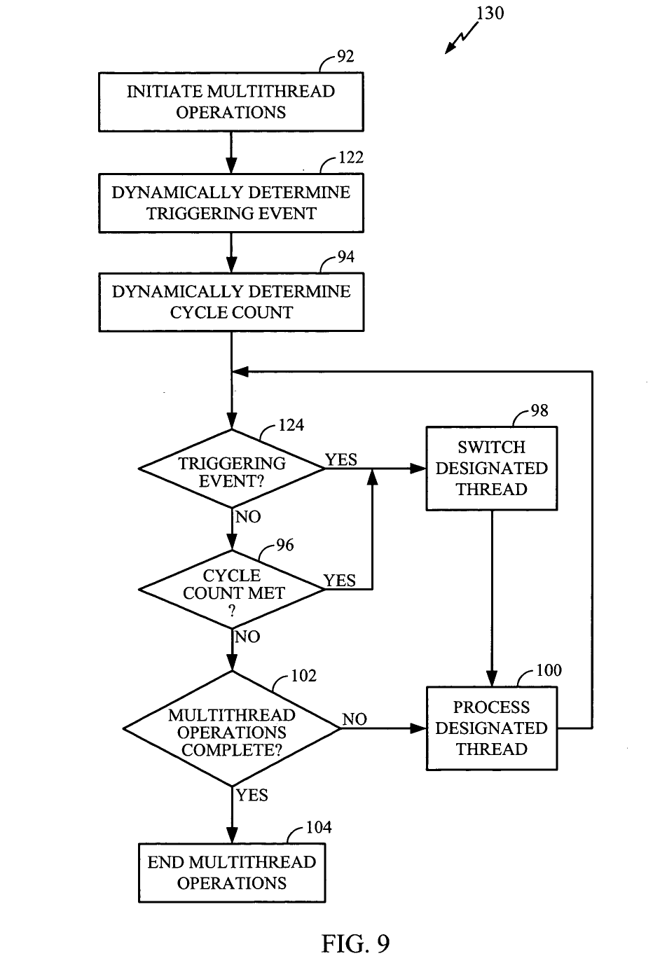

FIG. 9 details the process flow 130 deriving from combining the beneficial operations of VIIMT process flow 90 with VSOEMT process flow 120. The combination of both the triggering event at step 122 with the number of processor cycles at step 94 even further enhances multithread operations for DSP 40.

The disclosed subject matter demonstrates a substantial degree of flexibility when the various threads of a multithreaded processor demand differing amounts of processor resources. Thus, in the event that a set of instructions on one thread requires a greater proportion of processor resources, the present embodiment may allocate processor resources for a significantly larger amount of time than the amount allocated for other threads requiring a lesser amount of processor resources.

The present embodiment, therefore, provides a variable interval interleaved multithreading processor that includes a thread interval counter. The thread interval counter contains a dynamically determined number of cycles that each thread runs before switching to the next thread. The thread interval counter may be updated or dynamically determined by software, such as system software. The process of such embodiment uses the thread interval counter and the dynamically determined number of cycles to determine which thread runs next. This embodiment addresses the problem of improving the DSP performance by dynamically changing the thread interval counter to optimize the DSP to a given application or application mix. The thread interval counter may be changed dynamically during different stages in application operation to achieve an optimal interval.

The embodiment including a VISOEMT method and system, in summary, provides for variable event-based switching in combination with the operation of the thread interval counter. Thus, with the dynamically programmable thread switch counter, when the number of cycles reaches the dynamically determined thread switch timeout value or cycle count, the processor switches to the next thread. The thread interval counter may also be disabled by software, in which case the processor becomes a pure SOEMT processor. As a result, this embodiment allows the multithreaded processor to serve as both an SOEMT and IMT processor as the various applications that a processor may require.

The processing features and functions described herein can be implemented in various manners. For example, not only may DSP 40 perform the above-described operations, but also the present embodiments may be implemented in an application specific integrated circuit (ASIC), a microcontroller, a microprocessor, or other electronic circuits designed to perform the functions described herein. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the inventive faculty. Thus, the claimed subject matter is not intended to be limited to the embodiments shown herein but is to be accorded the widest scope consistent with the principles and novel features disclosed herein.

What is claimed is:

1. A method for processing instructions on a multithreaded processor, the multithreaded processor for processing a plurality of threads operating via a plurality of processor pipelines associated with the multithreaded processor, the method comprising the steps of:
predetermining at least one triggering event for the multithreaded processor to switch from a first thread to a second thread, said triggering event being variably and dynamically determined to optimize performance of the multithreaded processor;
processing a first set of instructions from a first thread until the occurrence of said triggering event;
switching the multithreaded processor in processing from the first thread to processing from a second thread upon the occurrence of said triggering event;
processing a second set of instructions from the second thread until the occurrence of a said triggering event;
switching the multithreaded processor in processing from the second thread to processing from a next thread upon the occurrence of said triggering event;
continuing the processing and switching steps during the operation of the multithreaded processor.

2. The method of claim 1, wherein the predetermining step further comprises the steps of:
predetermining at least one triggering event for the multithreaded processor to switch from a first thread to a second thread, said triggering event associating with a number of processor cycles, the number of processor cycles being determined to optimize the performance of the multithreaded processor; and
counting the number of processor cycles for determining whether said counted number of processor cycles equals the predetermined number of processor cycles, thereby establishing the presence of said triggering event.

3. The method of claim 1, wherein the predetermining step further comprises the steps of:
predetermining at least one triggering event for the multithreaded processor to switch from a first thread to a second thread, said triggering event associating with a variably and dynamically programmable event, said variably and dynamically programmable event determined to optimize the performance of the multithreaded processor; and
monitoring events occurring during the processing of each of the plurality of threads for determining the presence of said variably and dynamically programmable event, thereby establishing the presence of said triggering event.

4. The method of claim 1, further comprising the step of determining said at least one triggering event to be a cache miss occurring during the processing of the plurality of threads.

5. The method of claim 1, further comprising the step of determining said at least one triggering event to be an instruction miss occurring during the processing of the plurality of threads.

6. The method of claim 1, further comprising the step of determining said at least one triggering event to be a signal for performing a switch-on-signal process for switching from said first thread to said second thread.

7. The method of claim 1, further comprising the step of determining that an instruction has attempted to use a missing value from a load as said at least one triggering event for performing a switch-on-use process for switching from said first thread to said second thread.

8. The method of claim 1, further comprising the steps of:
predetermining a second triggering event for the multithreaded processor to switch from a first thread to a second thread, said second triggering event being variably and dynamically determined to optimize performance of the multithreaded processor; and
selectably and dynamically controlling whether the occurrence of said at least one triggering event or the occurrence of said second triggering event controls the switching of the multithreaded processor in processing from the first thread to processing from the second thread.

9. A multithreaded digital signal processor for processing a plurality of threads operating via a plurality of processor pipelines associated with the multithreaded processor, comprising:
means for predetermining at least one triggering event for the multithreaded processor to switch from a first thread to a second thread, said triggering event being variably and dynamically determined to optimize performance of the multithreaded processor;
means for processing a first set of instructions from a first thread until the occurrence of said triggering event;
means for switching the multithreaded processor in processing from the first thread to processing from a second thread upon the occurrence of said triggering event;
means for processing a second set of instructions from the second thread until the occurrence of said triggering event;
means for switching the multithreaded processor in processing from the second thread to processing from a next thread upon the occurrence of said triggering event; and
means for continuing the processing and switching steps during the operation of the multithreaded processor.

10. The system of claim 9, further comprising:
means for predetermining at least one triggering event for the multithreaded processor to switch from a first thread to a second thread, said triggering event associating with a number of processor cycles, said number of processor cycles being determined to optimize the performance of the multithreaded processor; and
means for counting said number of processor cycles for determining whether said counted number of processor cycles equals said number of processor cycles, thereby establishing the presence of the triggering event.

11. The system of claim 9, further comprising:
means for predetermining at least one triggering event for the multithreaded processor to switch from a first thread to a second thread, said triggering event associating with a variably and dynamically programmable event, said variably and dynamically programmable event determined to optimize the performance of the multithreaded processor; and
means for monitoring events occurring during the processing of each of the plurality of threads for determining the presence of said variably and dynamically programmable event, thereby establishing the presence of said triggering event.

12. The system of claim 9, further comprising means for determining the at least one triggering event to be a cache miss occurring during the processing of the plurality of threads.

13. The system of claim 9, further comprising means for determining the at least one triggering event to be an instruction miss occurring during the processing of the plurality of threads.

14. The system of claim 9, further comprising means for determining the at least one triggering event to be a signal for performing a switch-on-signal process for switching from said first thread to said second thread.

15. The system of claim 9, further comprising means for determining that an instruction has attempted to use a missing value from a load as said at least one triggering event for performing a switch-on-use process for switching from said first thread to said second thread.

16. The system of claim 9, further comprising:
means for predetermining a second triggering event for the multithreaded processor to switch from a first thread to a second thread, said second triggering event being variably and dynamically determined to optimize performance of the multithreaded processor; and
means for selectably and dynamically controlling whether the occurrence of said at least one triggering event or the occurrence of said second triggering event controls the switching of the multithreaded processor in processing from the first thread to processing from the second thread.

17. A multithreaded digital signal processor for processing a plurality of threads operating via a plurality of processor pipelines associated with the multithreaded processor, comprising:
an instruction queue for queuing instructions into a plurality of threads associated with said plurality of processor pipelines
issue logic associated with said instruction queue for receiving said plurality of threads and comprising thread switching logic for predetermining at least one triggering event causing the multithreaded processor to switch from a first thread to a second thread, said triggering event being variably and dynamically determined to optimize performance of the multithreaded processor;
an execution data path for processing a first set of instructions from a first thread until the occurrence of said triggering event;
said thread switching logic further for switching the multithreaded processor in processing from the first thread to processing from a second thread upon the occurrence of said triggering event;
said execution data path further for processing a second set of instructions from the second thread until the occurrence of said triggering event;
said thread switching logic further for switching the multithreaded processor in processing from the second thread to processing from a next thread upon the occurrence of said triggering event; and
said instruction queue, said issue logic, and said execution data path further associated for continuing the processing and switching steps during the operation of the multithreaded processor.

18. The system of claim 17, wherein said issue logic further comprises:
optimization logic associated with said thread switching logic for predetermining at least one triggering event for the multithreaded processor to switch from a first thread to a second thread, said triggering event associating with a number of processor cycles, said number of processor cycles being determined to optimize the performance of the multithreaded processor; and
processor cycle counting logic for counting said number of processor cycles and determining whether said counted number of processor cycles equals said number of processor cycles, thereby establishing the presence of said triggering event.

19. The system of claim 17, wherein said issue logic further comprises:
optimization logic associated with said thread switching logic for predetermining at least one triggering event for the multithreaded processor to switch from a first thread to a second thread, said triggering event associated with a variably and dynamically programmable event, said variably and dynamically programmable event determined to optimize the performance of the multithreaded processor; and
monitoring logic for monitoring events occurring during the processing of each of the plurality of threads for determining the presence of said variably and dynamically programmable event, thereby establishing the presence of said triggering event.

20. The system of claim 17, further comprising event monitoring logic for determining the at least one triggering event to be a cache miss occurring during the processing of the plurality of threads.

21. The system of claim 17, further comprising event monitoring logic for determining the at least one triggering event to be an instruction miss occurring during the processing of the plurality of threads.

22. The system of claim 17, further comprising event monitoring logic for determining the at least one triggering event to be a signal for performing a switch-on-signal process for switching from said first thread to said second thread.

23. The system of claim 17, further comprising event monitoring logic for determining that an instruction has attempted to use a missing value from a load as said at least one triggering event for performing a switch-on-use process for switching from said first thread to said second thread.

24. The system of claim 17, wherein said thread switching logic further comprises:
optimization logic for predetermining a second triggering event for the multithreaded processor to switch from a first thread to a second thread, said second triggering event being variably and dynamically determined to optimize performance of the multithreaded processor; and
switching event controlling logic for selectably and dynamically controlling whether the occurrence of said at least one triggering event or the occurrence of said second triggering event controls the switching of the multithreaded processor in processing from the first thread to processing from the second thread.

25. A computer usable medium having computer readable program code means embodied therein for processing instructions on a multithreaded processor, the multithreaded processor for processing a plurality of threads operating via a plurality of processor pipelines associated with the multithreaded processor, the method comprising the steps of:
computer readable program code means for predetermining at least one triggering event for the multithreaded processor to switch from a first thread to a second thread, said triggering event being variably and dynamically determined to optimize performance of the multithreaded processor;
computer readable program code means for processing a first set of instructions from a first thread until the occurrence of said triggering event;
computer readable program code means for switching the multithreaded processor in processing from the first thread to processing from a second thread upon the occurrence of said triggering event;
computer readable program code means for processing a second set of instructions from the second thread until the occurrence of said triggering event;
computer readable program code means for switching the multithreaded processor in processing from the second thread to processing from a next thread upon the occurrence of said triggering event; and
computer readable program code means for continuing the processing and switching steps during the operation of the multithreaded processor.

26. The computer usable medium of claim 25, further comprising:
computer readable program code means for predetermining at least one triggering event for the multithreaded processor to switch from a first thread to a second thread, said triggering event associating with a number of processor cycles, said number of processor cycles being determined to optimize the performance of the multithreaded processor; and
computer readable program code means for counting said number of processor cycles for determining whether said counted number of processor cycles equals said predetermined number of processor cycles, thereby establishing the presence of said triggering event.

27. The computer usable medium of claim 25, further comprising:
computer readable program code means for predetermining at least one triggering event for the multithreaded processor to switch from a first thread to a second thread, said triggering event associating with a variably and dynamically programmable event, said variably and dynamically programmable event determined to optimize the performance of the multithreaded processor; and
monitoring events occurring during the processing of each of the plurality of threads for determining the presence of said variably and dynamically programmable event, thereby establishing the presence of said triggering event.

28. The computer usable medium of claim 25, further comprising:
computer readable program code means for predetermining a second triggering event for the multithreaded processor to switch from a first thread to a second thread, said second triggering event being variably and dynamically determined to optimize performance of the multithreaded processor; and
selectably and dynamically controlling whether the occurrence of said at least one triggering event or the occurrence of said second triggering event controls the switching of the multithreaded processor in processing from the first thread to processing from the second thread.
